(19) United States
(12) Patent Application Publication
(10) Pub. No.: US 2026/0022267 A1
(43) Pub. Date: Jan. 22, 2026

(54) SILANE CROSSLINKABLE RESIN COMPOSITION, SILANE CROSSLINKED RESIN FORMED BODY, METHOD OF PRODUCING THEM, AND WIRING MATERIAL

(71) Applicant: FURUKAWA ELECTRIC CO., LTD., Tokyo (JP)

(72) Inventors: Kana MATSUMOTO, Tokyo (JP); Hiroki CHIBA, Tokyo (JP); Takanori YAMAZAKI, Tokyo (JP); Natsuki SATO, Tokyo (JP)

(73) Assignee: FURUKAWA ELECTRIC CO., LTD., Tokyo (JP)

(21) Appl. No.: 19/340,657

(22) Filed: Sep. 25, 2025

Related U.S. Application Data
(63) Continuation of application No. PCT/JP2024/009252, filed on Mar. 11, 2024.

(30) Foreign Application Priority Data
Mar. 27, 2023 (JP) 2023-049377

(51) Int. Cl. C09D 123/36; C08F 8/30; C08F 8/42; C08J 3/22; C08J 3/24; H01B 3/44

(52) U.S. Cl. CPC C09D 123/36; C08F 8/30; C08F 8/42; C08J 3/22; C08J 3/244; H01B 3/441; C08F 2810/20; C08J 2323/06; C08J 2323/08; C08J 2323/12

(57) ABSTRACT

Provided are a silane crosslinkable resin composition containing: 100 parts by mass of a base resin containing a polyolefin resin; parts by mass of a silane coupling agent graft-bonded to the base resin; 1 to 60 parts by mass of a compound having two or more imide structures; and 0.01˜5 parts by mass of a silanol condensation catalyst, a silane crosslinked resin formed body of the composition, a wiring material having the formed body, and a method of producing a silane crosslinkable resin composition and a silane crosslinked resin formed body including a step of melt-mixing a base resin, a silane coupling agent, a compound having two or more imide structures, an inorganic filler, an organic peroxide, and a silanol condensation catalyst at a specific ratio.

### CROSS-REFERENCE TO RELATED APPLICATIONS

This application is a Continuation of PCT International Application No. PCT/JP2024/009252 filed on Mar. 11, 2024, which claims priority under 35 U.S.C. §119(a) to Japanese Patent Application No. 2023-049377 filed in Japan on Mar. 27, 2023. Each of the above applications is hereby expressly incorporated by reference, in its entirety, into the present application.

### FIELD OF THE INVENTION

The present invention relates to a silane crosslinkable resin composition, a silane crosslinked resin formed body, a method of producing them, and a wiring material.

### BACKGROUND OF THE INVENTION

Wiring materials, such as insulated wires, cables, cords, optical fiber core wires or optical fiber cords (optical fiber cables), each of which is used in an electrical-or electronic-equipment field, and an industrial field, include coating layers (insulators, sheaths, etc.) formed of various resin formed bodies or rubber formed bodies. These formed bodies (coating layers) are required to have various characteristics depending on the application and intended use of the wiring material, and required to have, for example, appearance characteristics, and further heat resistance or the like from the viewpoints of safety and reliability.

Here, a typical technique for enhancing the heat resistance of the wiring material is, for example, a technique of forming a coating layer with a crosslinked formed body obtained by crosslinking a resin or rubber. As such a method of crosslinking a resin or rubber, an electron beam crosslinking method, a chemical crosslinking method, or the like can be generally adopted. Among chemical crosslinking methods, a silane crosslinking method is widely used because a silane crosslinkable resin composition can be easily crosslinked in a crosslinking step with high productivity without requiring a specially equipped facility.

As an insulated wire having a coating layer formed by the silane crosslinking method, for example, Patent Literatures 1 and 2 describe an insulated wire having an electric wire coating material obtained by water crosslinking a composition for an electric wire coating material containing a silane graft polyolefin, an unmodified polyolefin, a polyolefin modified with a specific functional group, a bromine-based flame retardant having a phthalimide structure, a crosslinking catalyst, zinc sulfide, or the like.

### CITATION LIST

### Patent Literatures

Patent Literature 1: JP-A-2012-057080 (“JP-A” means an unexamined published Japanese patent application)
Patent Literature 2: JP-A-2016-046084 (“JP-A” means an unexamined published Japanese patent application)

### SUMMARY OF THE INVENTION

### Technical Problem

It has been conventionally considered that the characteristics of the crosslinked resin formed body (coating layer) by the silane crosslinking method affect not only the kind and content of each component forming the crosslinked resin formed body but also the occurrence and reaction rate of the grafting reaction of the silane coupling agent and the direct crosslinking reaction between the resin and rubber, and various studies have been conducted. As a result of conducted studies on the characteristics of the crosslinked resin formed body from such a viewpoint, the present inventors have faced a problem that both the appearance characteristics and heat resistance of the crosslinked resin formed body cannot be achieved even when various refinements or improvements are made based on the above viewpoint. However, such a problem is not considered at all in Patent Literatures 1 and 2.

The present invention provides a silane crosslinked resin formed body having both excellent appearance characteristics in which an appearance defect and generation of protruding aggregates (lumps) are suppressed and sufficient heat resistance due to an increase in the crosslinking density, and a method of producing the same.

Also, the present invention provides a silane crosslinkable resin composition capable of forming the above-described silane crosslinked resin formed body having excellent characteristics, and a method of producing the same.

Further, the present invention provides a wiring material having the above-described silane crosslinked resin formed body with excellent characteristics, as a coating layer.

### Solution to Problem

The present inventors have continued studies on the problem that both the appearance characteristics and heat resistance cannot be achieved in the silane crosslinking method, and resultantly found that fastness and slowness (fast and slow levels) of the reaction rate (crosslinking rate) in the final crosslinking reaction (silanol condensation reaction) affect the characteristics of the crosslinked resin formed body, particularly the superiority and inferiority of the appearance characteristics and heat resistance. As a result of further studies based on this finding, the present inventors have found that a compound having two or more imide structures is allowed to coexist with a silanol condensation catalyst at a specific ratio during the final crosslinking reaction of a silane crosslinkable resin composition containing a silanol condensation catalyst at a specific ratio with respect to a base resin containing a polyolefin resin in which a silane coupling agent undergoes a grafting reaction, and thus the final crosslinking reaction is allowed to progress at a moderate rate, and it is possible suppress an appearance defect and generation of lumps while constructing a sufficient (dense) crosslinked structure by the silanol condensation reaction. As a result, the present inventors have found that a silane crosslinked resin formed body having both excellent appearance characteristics and sufficient heat resistance can be produced with high productivity. The present inventors have conducted further research based on these findings, and thus achieved the present invention.

That is, the above-described problems of the present invention are achieved by the following means.
<1> A silane crosslinkable resin composition including:
100 parts by mass of a base resin containing a polyolefin resin;
a silane coupling agent graft-bonded to the base resin;
1 to 60 parts by mass of a compound having two or more imide structures; and
0.01 to 5 parts by mass of a silanol condensation catalyst.
<2> The silane crosslinkable resin composition according to <1>, wherein the base resin does not contain a modified polyolefin resin modified with any of a carboxylic acid group, a methacrylic group, and an epoxy group.
<3> The silane crosslinkable resin composition according to <1> or <2>, wherein the compound having two or more imide structures does not contain a bromine-based flame retardant having a phthalimide structure.
<4> The silane crosslinkable resin composition according to any one of <1> to <3>, containing 1 to 200 parts by mass of an inorganic filler with respect to 100 parts of the base resin.
<5> A silane crosslinked resin formed body of the silane crosslinkable resin composition described in any one of <1> to <4>.
<6> A wiring material having the silane crosslinked resin formed body described in <5> as a coating layer.
<7> A method of producing a silane crosslinkable resin composition, including a step (1) of obtaining a silane crosslinkable resin composition by melt-mixing, 100 parts by mass of a base resin containing a polyolefin resin, 2 to 15 parts by mass of a silane coupling agent having a grafting reaction site capable of being graft-reacted with the base resin, 1 to 60 parts by mass of a compound having two or more imide structures, 1 to 200 parts by mass of an inorganic filler, 0.01 to 0.6 parts by mass of an organic peroxide, and 0.01 to 5 parts by mass of a silanol condensation catalyst,
wherein, when the step (1) is performed, in a case of melt-mixing all of the base resin in the following step (a), the step (1) includes the following step (a) and step (c), or in a case of melt-mixing a part of the base resin in the following step (a), the step (1) includes the following step (a), step (b), and step (c):
Step (a): a step of preparing a silane masterbatch by melt-mixing all or a part of the base resin, the inorganic filler, the silane coupling agent, and the organic peroxide at a temperature equal to or higher than a decomposition temperature of the organic peroxide;
Step (b): a step of preparing a catalyst masterbatch by melt-mixing a remainder of the base resin and the silanol condensation catalyst; and
Step (c): a step of melt-mixing the silane masterbatch with the silanol condensation catalyst or the catalyst masterbatch,
wherein the compound having two or more imide structures is mixed in at least one of the step (a) and the step (b).
<8> The method of producing a silane crosslinkable resin composition according to <7>, wherein a whole amount of the compound having two or more imide structures is mixed in the step (b).
<9> A method of producing a silane crosslinked resin formed body including the following step (1), step (2), and step (3):
Step (1): a step of obtaining a mixture by melt-mixing, 100 parts by mass of a base resin containing a polyolefin resin, 2 to 15 parts by mass of a silane coupling agent having a grafting reaction site capable of being graft-reacted with the base resin, 1 to 60 parts by mass of a compound having two or more imide structures, 1 to 200 parts by mass of an inorganic filler, 0.01 to 0.6 parts by mass of an organic peroxide, and 0.01 to 5 parts by mass of a silanol condensation catalyst;
Step (2): a step of obtaining a formed body by forming the mixture obtained in the step (1); and
Step (3): a step of obtaining a silane crosslinked resin formed body by bringing the formed body obtained in the step (2) and water into contact with each other,
wherein, when the step (1) is performed, in a case of melt-mixing all of the base resin in the following step (a), the step (1) includes the following step (a) and step (c), or in a case of melt-mixing a part of the base resin in the following step (a), the step (1) includes the following step (a), step (b), and step (c):
Step (a): a step of preparing a silane masterbatch by melt-mixing all or a part of the base resin, the inorganic filler, the silane coupling agent, and the organic peroxide at a temperature equal to or higher than a decomposition temperature of the organic peroxide;
Step (b): a step of preparing a catalyst masterbatch by melt-mixing a remainder of the base resin and the silanol condensation catalyst; and
Step (c): a step of melt-mixing the silane masterbatch with the silanol condensation catalyst or the catalyst masterbatch,
wherein the compound having two or more imide structures is mixed in at least one of the step (a) and the step (b).
<10> The method of producing a silane crosslinked resin formed body according to <9>, wherein a whole amount of the compound having two or more imide structures is mixed in the step (b).
<11> A silane crosslinkable resin composition produced by the production method described in <7> or <8>.
<12> A silane crosslinked resin formed body produced by the production method described in <9> or <10>.
<13> A wiring material having the silane crosslinked resin formed body described in <12> as a coating layer.

### Advantageous Effects of Invention

The present invention provides a silane crosslinked resin formed body having both excellent appearance characteristics in which the appearance defect and generation of lumps are suppressed and sufficient heat resistance due to an increase in the crosslinking density (due to densification of the crosslinked structure), and a method of producing the same.

Also, the present invention provides a silane crosslinkable resin composition capable of forming the above-described silane crosslinked resin formed body having excellent characteristics, and a method of producing the same.

Further, the present invention provides a wiring material having the above-described silane crosslinked resin formed body with excellent characteristics, as a coating layer.

The above-described and other features and advantages of the present invention will appear more fully from the following description.

### DESCRIPTION OF EMBODIMENTS

In the present invention, in a case where the content, physical properties, and the like of components are described by referring to numerical ranges, when the upper limit and the lower limit of a numerical range is separately described, any of the upper limits thereof and any of the lower limits thereof can be appropriately combined to set a specific numerical range. Meanwhile, in the present invention, the numerical ranges expressed with the term “to” refer to ranges including, as the lower limit and the upper limit, the numerical values before and after the term “to”. Note that, in the present invention, when a plurality of numerical ranges is set and described, the upper limit and the lower limit forming a numerical range are not limited to a specific combination described before and after the term “to” as a specific numerical range, and may be a numerical range in which the upper limit and the lower limit of each of the numerical ranges are appropriately combined.

Further, in the present invention, “(meth)acrylic acid” refers to either one or both of acrylic acid and methacrylic acid, and “(meth)acrylic acid ester” refers to either one or both of an acrylic acid ester and a methacrylic acid ester.

### Silane Crosslinkable Resin Composition

The silane crosslinkable resin composition of the present invention contains 100 parts by mass of a base resin containing a polyolefin resin, a silane coupling agent graft-bonded to the base resin, 1 to 60 parts by mass of a compound having two or more imide structures, and 0.01 to 5 parts by mass of a silanol condensation catalyst.

Although details will be described later, the silane crosslinkable resin composition of the present invention contains a silane crosslinkable resin in which a silane coupling agent is graft-bonded to (graft-reacted with) a base resin, and contains a compound having two or more imide structures and a silanol condensation catalyst in a mixed state with the base resin. In addition, the silane crosslinkable resin composition of a preferred embodiment described later contains a silane crosslinkable resin in which a silane coupling agent bonded to or dissociated from an inorganic filler is graft-bonded to (graft-reacted with) a base resin, together with the inorganic filler, in addition to the compound having two or more imide structures and the silanol condensation catalyst.

In the silane crosslinkable resin composition of the present invention, a specific amount of the compound having two or more imide structures coexists with a specific amount of the silanol condensation catalyst, and thus it is considered that a silanol condensation reaction can be caused to occur and progress at a moderate reaction rate under mild conditions without requiring a specially equipped facility for crosslinking, such as a chemical crosslinking tube or an electron beam crosslinking machine. As a result, it is possible to suppress the appearance defect and generation of lumps due to an increase in rate of the silanol condensation reaction, and to realize excellent appearance characteristics. In the present invention, the term “appearance defect” refers to a defect caused by foaming on the surface (appearance) of a silane crosslinked resin formed body (coating layer) obtained from the silane crosslinkable resin composition, and a defect such as recesses and protrusions or roughness: so-called melt fracture. In addition, the term “lumps” refer to gel-like protruding aggregates (gel lumps) formed by final crosslinking (silanol condensation reaction) that are present on the surface of the silane crosslinked resin formed body (coating layer), or aggregated lumps in which raw materials are aggregated due to being incompatible. Further, it is possible to suppress delaying of the formation of a crosslinked structure (delaying of crosslinking construction) due to a decrease in rate of the silanol condensation reaction, and eventually, a decrease in crosslinking density (decrease in heat resistance) and deterioration in productivity.

In the present invention, regarding the silanol condensation reaction, a moderate (adequate) reaction rate (crosslinking rate) cannot be uniquely determined by the content of the silanol condensation catalyst, the contact conditions with water, and the like. Whether or not the reaction rate of the silanol condensation reaction is moderate can be judged and evaluated by maintaining the catalytic activity of the silanol condensation catalyst and, for example, passing an appearance characteristic test and a heating deformation test described in Examples described later.

As described above, in the silane crosslinkable resin composition of the present invention, it is possible to adjust the reaction rate of the silanol condensation reaction to a moderate reaction rate and realize a silane crosslinked resin formed body in which both the appearance characteristics and heat resistance, which are conflicted with each other depending on the fastness and slowness of the silanol condensation reaction, are achieved in a well-balanced manner. Accordingly, the silane crosslinkable resin composition of the present invention is suitably used for the silane crosslinked resin formed body and the wiring material of the present invention.

### Silane Crosslinked Resin Formed Body

The silane crosslinked resin formed body of the present invention is a crosslinked formed body of the silane crosslinkable resin composition of the present invention, and specifically a crosslinked resin formed body obtained by forming the silane crosslinkable resin composition of the present invention into a predetermined shape and size and then subjecting the formed body to silane crosslinking (silanol condensation reaction) (a formed body of a silanol condensate of the silane crosslinkable resin composition).

Although details will be described later, the silane crosslinked resin formed body of the present invention is formed by a silanol condensation reaction at a moderate reaction rate using a compound having two or more imide structures and a silanol condensation catalyst, and has a crosslinked structure in which the base resin is moderately silane-crosslinked (structure crosslinked using a silane coupling agent or a silanol condensate thereof). Accordingly, the silane crosslinked resin formed body of the present invention exhibits excellent appearance characteristics and sufficient heat resistance in a well-balanced manner. In addition, in the silane crosslinked resin formed body of a preferred embodiment described later, it is considered that an inorganic filler is incorporated in a part of the crosslinked structure as described later. Therefore, as will be described later, in the silane crosslinked resin formed body of a preferred embodiment, a crosslinked structure (not involving an inorganic filler) between base resins and a crosslinked structure involving an inorganic filler are constructed in a well-balanced manner, and excellent appearance characteristics and sufficient heat resistance are exhibited at a high level in a well-balanced manner.

The silane crosslinked resin formed body of the present invention is formed into an appropriate shape and size depending on the application, for example, the intended use of the wiring material of the present invention as described later.

Hereinafter, each component to be used in the present invention will be explained.

One kind or two or more kinds of each component can be used.

In the present invention and the present specification, when simply referred to as “resin”, it means a resin in which a silane coupling agent does not undergo a grafting reaction. Meanwhile, a resin in which a silane coupling agent undergoes a grafting reaction may be referred to as “silane crosslinkable resin”, “a silane graft resin”, or the like.

In addition, the term “(co)polymer” is used in the sense of including a resin or rubber thereof.

### <Base Resin>

The silane crosslinkable composition of the present invention preferably contains a polyolefin resin as its base resin and is preferably formed of the polyolefin resin. As described above, the base resin contains a polyolefin resin (silane crosslinkable resin or silane graft resin) in which a silane coupling agent undergoes a grafting reaction.

The silane graft resin contained in the base resin is formed of a silane coupling agent and a polyolefin resin described later, and is a resin prepared by a grafting reaction of the silane coupling agent with the polyolefin resin. In this silane graft resin, the graft-reacting amount of the silane coupling agent is not particularly limited. Ordinarily, the amount may be any graft-reacting amount as long as it is a graft-reacting amount obtained by reacting the silane coupling agent with the polyolefin resin in a composition amount as described later.

The silane graft resin may be synthesized as appropriate, or a commercially available product may be used. The silane graft resin is obtained by reacting the polyolefin resin and the silane coupling agent at a temperature equal to or higher than the decomposition temperature of the organic peroxide. Specific reaction conditions are not particularly limited, and preferable examples thereof include the melt-mixing conditions in the step (1) or the step (a) described later after the content of the organic peroxide is set to the range described later. The commercially available product of the silane graft resin is, for example, Linklon (trade name, manufactured by Mitsubishi Chemical Corporation).

### (Polyolefin Resin)

The polyolefin resin that forms the silane graft resin (before the grafting reaction) is not particularly limited as long as it is a resin formed of a polymer prepared by polymerizing or copolymerizing a compound having an ethylenically unsaturated bond (an olefin compound). Known resins used in conventional resin compositions can be used. In the present invention, the polyolefin resin encompasses, in addition to the resin formed of a polymer prepared by polymerizing or copolymerizing an olefin compound, an elastomer or rubber formed of this polymer.

The polyolefin resin has a grafting reaction site (e.g. an unsaturated bond site of a carbon chain or a carbon atom having a hydrogen atom) capable of being graft-reacted with a grafting reaction site of a silane coupling agent. Examples of the polyolefin resin include resins of polyethylene (PE), polypropylene (PP), an ethylene-α-olefin copolymer, a copolymer having an acid copolymerized component or an acid ester copolymerized component; and styrene-based elastomers.

### —Polyethylene Resin—

The polyethylene resin (PE) is not particularly limited as long as it is a resin of a polymer containing an ethylene component as a main component, and examples thereof include resins such as high-density polyethylene (HDPE), low-density polyethylene (LDPE), ultra-high molecular weight polyethylene (UHMW-PE), linear low-density polyethylene (LLDPE), and ultra-low density polyethylene (VLDPE). Among these resins, resins such as linear low-density polyethylene and low-density polyethylene are preferable.

### —Polypropylene Resin—

The polypropylene resin (PP) is not particularly limited as long as it is a resin of a polymer containing a propylene component as a main component, and examples thereof include resins of random polypropylene and block polypropylene in addition to a homopolymer of propylene.

### —Ethylene-α-Olefin Copolymer Resin—

The ethylene-α-olefin copolymer resin is preferably a copolymer of ethylene and α-olefin with 3 to 12 carbon atoms (however, those included in the polyethylene resins and the polypropylene resins described above are excluded). Examples thereof include an ethylene-propylene copolymer resin (however, those included in the polypropylene resins are excluded), an ethylene-butylene copolymer resin, and an ethylene-α-olefin copolymer resin synthesized in the presence of a single-site catalyst.

### —Resin of Copolymer Having Acid Copolymerized Component or Acid Ester Copolymerized Component—

The compound that leads an acid copolymerized component or an acid ester copolymerized component in the resin of the copolymer having the acid copolymerized component or the acid ester copolymerized component is not particularly limited, and examples thereof include carboxylic acid compounds such as (meth)acrylic acid, and acid ester compounds such as vinyl acetate and (meth)acrylic acid ester. The (meth)acrylic acid ester is not particularly limited, and examples thereof include alkyl (meth)acrylate. The alkyl group of the alkyl (meth)acrylate is preferably one with 1 to 12 carbon atoms.

The resin of a copolymer having an acid copolymerized component or an acid ester copolymerized component is not particularly limited, and examples thereof include resins such as an ethylene-vinyl acetate copolymer (EVA), an ethylene-(meth)acrylic acid copolymer, and an ethylene-alkyl (meth)acrylate copolymer. Specific examples of the resin of the ethylene-alkyl (meth)acrylate copolymer include resins of an ethylene-methyl acrylate copolymer (EMA), an ethylene-ethyl acrylate copolymer (EEA), and an ethylene-butyl acrylate copolymer (EBA).

—Styrene-Based Elastomer—The styrene-based elastomer refers to an elastomer including a polymer having a constituent derived from an aromatic vinyl compound in a molecule. Examples of the styrene-based elastomer include block and random copolymers of a conjugated diene compound and an aromatic vinyl compound, or hydrogenated products thereof. Specific examples thereof include styrene-ethylene-butylene-styrene block copolymer (SEBS), styrene-isoprene-styrene block copolymer (SIS), hydrogenated SIS, styrene-butadiene-styrene block copolymer (SBS), hydrogenated SBS, styrene-ethylene-ethylene-propylene-styrene block copolymer (SEEPS), styrene-ethylene-propylene-styrene block copolymer (SEPS), styrene-butadiene rubber (SBR), hydrogenated styrene-butadiene rubber (HSBR), hydrogenated acrylonitrile-butadiene rubber (HNBR).

### —Modified Polyolefin Resin—

The base resin may contain a resin obtained by modifying a polyolefin resin.

Examples of the modified polyolefin resin include a modified polyolefin resin modified with any group of a carboxylic acid group, a methacrylic group, and an epoxy group, and a modified polyolefin resin modified with any group of a carboxylic acid group, an acid anhydride group, an amino group, an acrylic group, a methacrylic group, and an epoxy group. The modified polyolefin resin is not particularly limited, and examples thereof include a resin formed of a polymer obtained by graft-polymerizing a compound having at least one kind of the above groups to a polyolefin resin, a resin formed of a polymer obtained by copolymerizing a compound having at least one kind of the above groups and an olefin compound. Specific examples thereof include a maleic acid-modified polyethylene resin, a maleic acid-modified polypropylene resin, a resin formed of an ethylene-glycidyl methacrylate (E-GMA) copolymer, and a resin formed of an ethylene-methyl methacrylate (EMMA) copolymer.

Regarding the modified polyolefin resin and the compound having at least one kind of the above groups (corresponding to a “compound into which a functional group is introduced” in each of the patent literatures), it is possible to appropriately refer to, for example, the contents described in Patent Literature 1 or 2, and the contents are directly incorporated as a part of the present specification.

### —Oil—

The polyolefin resin may contain various oils used as plasticizers or softeners as desired. Examples of such oils include oils as plasticizers used for a polyolefin resin or mineral oil softeners for rubber. As the oil, aromatic oil, paraffin oil, or naphthene oil is suitably used, and paraffin oil is more preferable.

### (Composition of Base Resin)

The base resin may contain any one of the above resins singly, or may contain a plurality of resins. In the present invention, the base resin preferably contains a polyethylene resin. From the viewpoint of improving manufacturability and improving mechanical characteristics, the base resin may contain a polyethylene resin and a polyolefin resin other than the polyethylene resin. More preferably, the base resin is formed of polyethylene resin.

However, it is preferable that the base resin does not contain the modified polyolefin resin. When the base resin does not contain the modified polyolefin resin, appearance characteristics can be further improved without impairing sufficient heat resistance, and a silane crosslinked resin formed body having both high appearance characteristics and sufficient heat resistance can be realized. In the present invention, “the base resin does not contain the modified polyolefin resin” means that the modified polyolefin resin is not actively contained or mixed as the base resin, and it is not excluded that the modified polyolefin resin is unavoidably contained or mixed. For example, the content rate of the modified polyolefin resin in the base resin can be 4.0 mass % or less with respect to 100 mass % of the base resin, and is preferably less than 0.5 mass %.

When the base resin contains a plurality of resins, the resins or oils may be contained at a content rate of 100 mass % in total, and the content is appropriately set according to the physical properties, applications, and the like of the silane crosslinked resin formed body. For example, the content rate of the polyethylene resin in 100 mass % of the base resin is preferably 20 to 100 mass %, more preferably 30 to 90 mass %. It is also a preferable aspect that the lower limit of the content rate of the polyethylene resin is set to 70 mass %. In addition, the content rate of the polypropylene resin, the ethylene-α-olefin copolymer resin, or the resin of a copolymer having an acid copolymerized component or an acid ester copolymerized component in 100 mass % of the base resin is preferably 0 to 80 mass %, more preferably 10 to 70 mass %. Meanwhile, the content rate of the styrene-based elastomer in 100 mass % of the base resin is preferably 0 to 50 mass %, more preferably 5 to 20 mass %. The content rate of the oil in 100 mass % of the base resin is preferably 0 to 50 mass %, more preferably 5 to 20 mass %. When the base resin contains the modified polyolefin resin, the content rate of the modified polyolefin resin in 100 mass % of the base resin is not particularly limited, and may be 5 to 70 mass %, 5 to 40 mass %, or 10 to 30 mass %.

### <Compound Having Two or More Imide Structures>

The compound having two or more imide structures (hereinafter, may be referred to as “polyimide compound”) is a compound having two or more structures in which two carbonyl groups are bonded to an amino group (—NR—) or ammonia: —CO—NR₂—CO— in the molecular structure. Here, R₂ represents a hydrogen atom, a substituent, or a bonding portion. The substituent that can be taken as R₂ is not particularly limited, and examples thereof include an alkyl group, an alkenyl group, and an aryl group.

In the polyimide compound, the imide structure may be a linear imide structure, and is preferably a cyclic imide structure (an imide structure is incorporated to form a ring). In the cyclic imide structure, one or more imide structures may be incorporated into one ring (cyclic chain). In the present invention, the term “compound having two or more imide structures” ordinarily encompasses a form of a compound in which two imide structures exist independently via an atom or a linking group (e.g. a compound represented by Formula (1) or (2) described later), a form of a compound in which a carbonyl group, an amino group, or ammonia of one imide structure is shared with the other imide structure (e.g. a compound having an isocyanurate ring structure described later), and a form of a compound in which the two forms described above are further mixed. The form of a compound having a carbonyl group, an amino group, or ammonia of one imide structure shared with the other imide structure is, for example, a compound containing a chain represented by —CO—NR₂—CO—NR₂—CO— (R₂ is as described above), and this compound is interpreted to have two imide structures. The chain may be incorporated into the ring in the polyimide compound, and the ring structure formed of three imide structures is, for example, an isocyanurate ring structure.

Examples of the cyclic imide structure include a ring structure having one imide structure in the ring, such as a maleimide ring structure, a succinimide ring structure, a glutarimide ring structure, or a ring structure in which a benzene ring is condensed to these ring structures; and a ring structure having two or more imide structures in the ring, such as an isocyanurate ring structure. A ring structure having one imide structure in the ring is preferable, and a maleimide ring structure or a ring structure in which a benzene ring is condensed to a maleimide ring structure (e.g. a phthalimide structure) is more preferable. The bonding portion in the cyclic imide structure may be any atom, and is preferably an atom forming a cyclic structure, more preferably a nitrogen atom (R₂)) forming a cyclic structure.

The number of imide structures of the polyimide compound may be 2 or more in one molecule. When the polyimide compound is a polymer compound, preferably a polymer, the number of imide structures present in one molecule can be appropriately set according to the molecular weight and the like of the polymer compound. For example, the number of imide structures can be 2 to 100. Meanwhile, when the polyimide compound is a low molecular weight compound, ordinarily a non-polymer compound (also referred to as “monomer compound”), the number of imide structures present in one molecule is, for example, preferably 2 to 4, more preferably 2. The two or more imide structures in one molecule may be different from each other, and are preferably identical to each other.

The polyimide compound may be a polymer compound (polymer), and is preferably a low molecular weight compound (non-polymer).

Examples of the polyimide compound include various compounds as described later. From the viewpoint of environmental compatibility, a compound other than the bromine-based flame retardant having a phthalimide structure (i.e. the polyimide compound does not contain the bromine-based flame retardant having a phthalimide structure) is preferable, a compound other than a flame retardant (i.e. the polyimide compound does not contain a flame retardant) is more preferable, and a compound other than a polyimide compound having a halogen atom (i.e. the polyimide compound does not contain a polyimide compound having a halogen atom) is still more preferable.

In the present invention, “the polyimide compound does not contain the bromine-based flame retardant or the like” means that the polyimide compound does not actively contain or mix the bromine-based flame retardant or the like as the polyimide compound, and does not exclude that the polyimide compound unavoidably contains the bromine-based flame retardant or the like. For example, the polyimide compound may contain a bromine-based flame retardant or the like in an amount of 0.5 mass % or less with respect to 100 mass % of the polyimide compound.

The polyimide compound is not particularly limited, and examples thereof include a monomer compound that forms a bismaleimide resin, and an imide compound represented by the following Formula (1) or (2) and having two cyclic imide structures is preferable, and a compound represented by the following Formula (1) is more preferable.

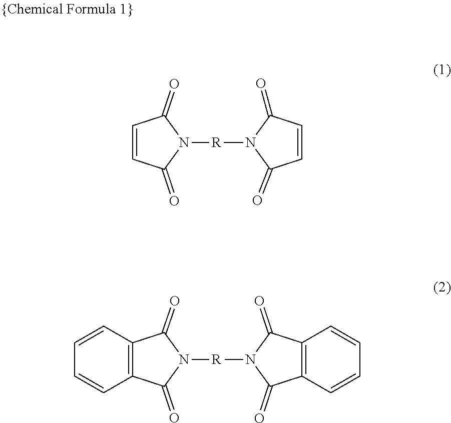

In Formulas (1) and (2), R represents a linking group.

The linking group that can be taken as R is not particularly limited, and examples thereof include an alkylene group, an alkenylene group, an arylene group, an oxygen atom (—O—), a sulfur atom (—S—), an imino group, or a group related to combination thereof.

The alkylene group that can be taken as R is not particularly limited, and may be linear, branched, and cyclic, and is preferably linear or branched. The number of carbon atoms in the alkylene group is not particularly limited, and is, for example, preferably 1 to 12, more preferably 1 to 6, and still more preferably 1 to 3. The bonding position of the alkylene group is not particularly limited, and may be on an identical carbon atom or different carbon atoms. When the different carbon atoms are used as the bonding positions, carbon atoms located at both ends of the longest carbon chain forming the alkylene group are preferable.

The alkenylene group that can be taken as R is not particularly limited, and may be linear, branched, and cyclic, and is preferably linear or branched. The number of carbon atoms in the alkenylene group is not particularly limited, and is, for example, preferably 2 to 6, more preferably 2 to 3.

The arylene group that can be taken as R is not particularly limited, and may be a monocyclic arylene group or a polycyclic arylene group. The monocyclic arylene group is preferable. The number of carbon atoms in the arylene group is not particularly limited, and is, for example, preferably 6 to 24, more preferably 6 to 10, and still more preferably 6. In the case of the monocyclic arylene group (phenylene group), the bonding position is not particularly limited, and may be any of a 1,2-phenylene group, a 1,3-phenylene group, and a 1,4-phenylene group. The 1,3-phenylene group or 1,4-phenylene group is preferable, and the 1,4-phenylene group is more preferable.

The imino group that can be taken as R is not particularly limited, and examples thereof include a group represented by —NR^{N}—. R^{N} represents a hydrogen atom, an alkyl group with 1 to 6 carbon atoms, or an aryl group with 6 to 10 carbon atoms. The hydrogen atom is preferable.

The group related to the above combination that can be taken as R is not particularly limited, and appropriate groups or atoms can be combined. The number of groups and atoms forming the group related to the combination is not particularly limited, and may be, for example, 2 to 10, and is preferably 3 to 7. Examples of the group related to the combination include a group formed of a combination of an alkylene group and an arylene group, a group formed of a combination of an arylene group and an oxygen atom, a group formed of a combination of an alkylene group, an arylene group, and an oxygen atom, and a group formed of a combination of an alkylene group and a sulfur atom. Examples of the group formed of a combination of an alkylene group and an arylene group include arylene group-alkylene group-arylene group. Examples of the group formed of a combination of an arylene group and an oxygen atom include arylene group-oxygen atom-arylene group. Examples of the group formed of a combination of an alkylene group, an arylene group, and an oxygen atom include arylene group-oxygen atom-arylene group-alkylene group-arylene group-oxygen atom-arylene group. Examples of the group formed of a combination of an alkylene group and a sulfur atom include alkylene group-sulfur atom-sulfur atom-alkylene group.

The arylene group contained in the group related to the combination is preferably a phenylene group, and is preferably a 1,4-phenylene group.

In the present invention, the number of atoms forming a linking group R is not particularly limited, and may be 3 to 100, and is more preferably 20 to 70. The number of linking atoms of the linking group is preferably 50 or less, more preferably 5 to 30, and still more preferably 7 to 20. The number of linking atoms refers to the minimum number of atoms connecting nitrogen atoms contained in two maleimide rings. For example, when the linking group R is -(1,4-phenylene group)-CH₂-(1,4-phenylene group)-, the number of atoms forming the linking group is 23, but the number of linking atoms is 9.

As the linking group that can be taken as R, an alkylene group, an arylene group, a group formed of a combination of an alkylene group and an arylene group, or a group formed of a combination of an alkylene group, an arylene group, and an oxygen atom is preferable.

The compound represented by Formula (1) or (2) may be unsubstituted or may have a substituent. The substituent that the compounds may have is not particularly limited, and examples thereof include an alkyl group, an alkenyl group, an alkynyl group, an aryl group, a heterocyclic group, an alkoxy group, an amino group, and a halogen atom. It is preferable not to contain a halogen atom among the substitutes. For example, an alkyl group is preferable.

The number of carbon atoms in the alkyl group is not particularly limited, and is preferably 1 to 20, preferably 1 to 6. The number of carbon atoms in the alkenyl group or the alkynyl group is not particularly limited, and is preferably 2 to 20. The number of carbon atoms of the aryl group is the same as the number of carbon atoms of the arylene group that can be taken as R. Examples of the heterocyclic group include a ring group having at least one oxygen atom, sulfur atom, or nitrogen atom, and the heterocyclic group is preferably a 5-membered or 6-membered heterocyclic group with 2 to 20 carbon atoms. The heterocyclic group includes an aromatic heterocyclic group and an aliphatic heterocyclic group. The number of carbon atoms of the alkyl group forming the alkoxy group is not particularly limited, and is the same as the number of carbon atoms of the alkyl group. The amino group includes an amino group in which one or two of hydrogen atoms are substituted with an alkyl group, an aryl group, or a heterocyclic group, in addition to an unsubstituted amino group (—NH₂). The halogen atom is not particularly limited, and examples thereof include a fluorine atom, a chlorine atom, and a bromine atom. The bromine atom is preferable.

The number of substituents of the compound represented by Formula (1) or (2) is not particularly limited, and may be one or more and may be equal to or less than the number of hydrogen atoms in the compounds. In the compound represented by Formula (2), all four hydrogen atoms of benzene rings may be substituted. The substitution position of the substituent of the compound represented by Formula (1) or (2) is not particularly limited.

Examples of the compound represented by Formula (1) include phenylmethane maleimide, o-, m- or p-phenylene bismaleimide, 4-methyl-1,3-phenylene bismaleimide, 1,6-bismaleimide (2,2,4-trimethyl)hexane, 4,4′-diphenylmethane bismaleimide, bisphenol A diphenyl ether bismaleimide, 3,3′-dimethyl-5,5′-diethyl-4,4′-diphenylmethane bismaleimide, 4,4′-diphenyl ether bismaleimide, alkylene bismaleimide with 1 to 6 carbon atoms, 1,3-bis(3-maleimidophenoxy)benzene, and 1,3-bis(4-maleimidophenoxy)benzene.

Examples of the compound represented by Formula (2) include bromine-based flame retardants such as ethylene bis(tetrabromophthalimide) and ethylene bis(tribromophthalimide).

Examples of the polyimide compound having an isocyanurate ring structure include triallyl isocyanurate, and bromine-based flame retardants such as tris(2,3-dibromopropyl) isocyanurate.

### <Silanol Condensation Catalyst>

The silanol condensation catalyst is capable of causing a condensation reaction (acceleration), in the presence of water (moisture), of a silanol condensable reaction site of the silane coupling agent grafted to the base resin. Due to the function of this silanol condensation catalyst, base resins are crosslinked through the silane coupling agent.

The forgoing silanol condensation catalyst is not particularly limited. Examples thereof include organic tin compounds, metal soaps, and platinum compounds. As the organic tin compounds, examples thereof include organic tin compounds, such as dibutyltin dilaurate, dioctyltin dilaurate, dibutyltin dioctylate, and dibutyltin diacetate.

### <Silane Coupling Agent>

The silane crosslinkable resin composition of the present invention contains a silane coupling agent graft-bonded to a polyolefin resin (base resin). The polyolefin resin to which the silane coupling agent is graft-bonded is preferably prepared by subjecting the silane coupling agent and the polyolefin resin to a grafting reaction by a method described later.

The silane coupling agent for forming the silane graft resin (before the grafting reaction) is not particularly limited as long as it has a grafting reaction site (group or atom) that can undergo a grafting reaction with a grafting reactive site of the polyolefin resin in the presence of a radical generated by decomposition of an organic peroxide, and a silanol condensable reaction site. When the silane coupling agent used in the present invention has a hydrolyzable silyl group, particularly an alkoxysilyl group, as a silanol condensable reaction site, it is preferable from the viewpoint that the final crosslinking reaction (particularly silanol condensation reaction) exhibits equivalent reactivity.

Examples of these silane coupling agents include silane coupling agents which have been used in the conventional silane crosslinking method. Preferable examples of the silane coupling agent include silane coupling agents having an ethylenically unsaturated group and a hydrolyzable silyl group (e.g. alkoxysilyl group). Specific examples thereof include vinylalkoxysilane such as vinyltrimethoxysilane, vinyltriethoxysilane, vinyltributoxysilane, vinyldimethoxyethoxysilane, vinyldimethoxybutoxysilane, vinyldiethoxybutoxysilane, allyltrimethoxysilane, allyltriethoxysilane, and vinyltriacetoxysilane, and (meth)acryloxysilane such as methacryloxypropyltrimethoxysilane, methacryloxypropyltriethoxysilane, and methacryloxypropylmethyldimethoxysilane. Among these silane coupling agents, in the present invention, vinylalkoxysilane is preferable, and vinyltrimethoxysilane or vinyltriethoxysilane is particularly preferable from the viewpoint that the grafting reaction with the polyolefin resin and the silanol condensation reaction rapidly progress.

The silane coupling agent may be used singly alone, or in combination of 2 or more kinds thereof. In addition, the silane coupling agent may be used as it is or may be diluted with a solvent or the like.

### <Inorganic Filler>

The silane crosslinkable composition of the present invention also preferably contains an inorganic filler. In particular, when the silane coupling agent and the polyolefin resin are subjected to a grafting reaction in preparation of the silane crosslinkable resin composition, it is preferable to allow the inorganic filler to coexist from the viewpoint of suppressing volatilization of the silane coupling agent, suppressing a condensation reaction between the silane coupling agents, and further improving appearance characteristics and heat resistance.

The inorganic filler is not particularly limited as long as it is ordinarily used. However, preferred are those having, on their surfaces, a site that can be chemically bonded by a hydrogen bond or a covalent bond and the like, or an intermolecular bond with a silanol condensable reaction site of the silane coupling agent. The site that can be chemically bonded with the silane coupling agent is not particularly limited, and examples thereof include an OH group (OH group of hydroxyl group, of water molecule in hydrous substance or crystallized water, or of carboxyl group), amino group, a SH group.

The inorganic filler is allowed to coexist during the silane grafting reaction, and as a result of which it is possible to form a silane graft resin in which a silane coupling agent weakly bonded to the inorganic filler undergoes a grafting reaction, and a silane graft resin in which a silane coupling agent strongly bonded to the inorganic filler undergoes a grafting reaction. These two kinds of silane graft resins are subjected to a crosslinking reaction, and as a result of which it is possible to form a silane crosslinked resin formed body exhibiting a high crosslinking density (heat resistance) without impairing excellent appearance characteristics. Here, the weak bonding to the inorganic filler includes mutual action caused by hydrogen bonding, mutual action between ions, partial charges, or dipoles, action caused by adsorption, and the like. Further, the strong bonding to the inorganic filler includes chemical bonding to a site capable of being chemically bonded to the surface of the inorganic filler, and the like.

Examples of the inorganic filler include those ordinarily used in the resin composition, and examples thereof include metal hydrate, such as a compound having a hydroxyl group or crystallized water, e.g. aluminum hydroxide, magnesium hydroxide, boehmite, calcium carbonate, magnesium carbonate, calcium silicate, magnesium silicate, calcium oxide, magnesium oxide, aluminum oxide, aluminum nitride, aluminum borate whisker, hydrated aluminum silicate, hydrated magnesium silicate, basic magnesium carbonate, hydrotalcite, and talc. Further, examples thereof include boron nitride, silica (crystalline silica, amorphous silica, and the like), carbon black, clay (calcined clay), zinc oxide, tin oxide, titanium oxide, molybdenum oxide, antimony trioxide, a silicone compound, quartz, zinc borate, white carbon, zinc borate, zinc hydroxystannate, and zinc stannate. Among these inorganic fillers, aluminum hydroxide or magnesium hydroxide is preferable.

In the present invention, when the above-described polyimide compound does not contain the bromine-based flame retardant having a phthalimide structure, it is preferable that antimony trioxide is not contained as the inorganic filler.

In the present invention, the term “not containing antimony trioxide as the inorganic filler” means that antimony trioxide is not actively contained or mixed, and it does not exclude that the silane crosslinkable resin composition and the silane crosslinked resin formed body unavoidably contain antimony trioxide as the inorganic filler. For example, the silane crosslinkable resin composition and the silane crosslinked resin formed body may contain antimony trioxide in an amount of less than 30 parts by mass, preferably less than 10 parts by mass, with respect to 100 parts by mass of the base resin.

The inorganic filler is preferably in the form of particles, and an average particle diameter thereof is preferably 0.2 to 10 μm, more preferably 0.3 to 8 μm, further preferably 0.4 to 5 μm, and particularly preferably 0.4 to 3 μm. The average particle diameter is obtained by dispersing the inorganic filler in alcohol or water, and then measuring using an optical particle diameter measuring device, such as a laser diffraction/scattering particle diameter distribution measuring device.

As the inorganic filler, an inorganic filler surface-treated using various surface treatment agents can also be used.

One kind of the inorganic filler may be used singly, or two or more kinds thereof may be used in combination.

### <Organic Peroxide>

When synthesizing the silane graft resin, an organic peroxide is preferably used. The organic peroxide has a function of causing and accelerating a grafting reaction of the base resin with a silane coupling agent by generating radicals during thermal decomposition. The organic peroxide is not particularly limited, and for example, compounds represented by formulas: R^{1A}—OO—R^{2A}, R^{3A}—OO—C(═O)R^{4A}, and R^{5A}C(═O)—OO(C═O)R^{6A} are preferable. Here, R^{1A} to R^{6A} each independently represent an alkyl group, an aryl group, or an acyl group. Among R^{1A} to R^{6A} of each of the compounds, a compound in which all of R^{1A} to R^{6A} are alkyl groups or a compound in which any one of R^{1A} to R^{6A} is an alkyl group and the rest is an acyl group is preferable.

As the decomposition temperature measured by the method described in JP-A-2016-121203, the decomposition temperature of the organic peroxide is preferably 80 to 195° C. and particularly preferably 125 to 180° C.

Examples of such an organic peroxide include an organic peroxide described in paragraph [0036] of JP-A-2016-121203, the contents of which are incorporated herein by reference. Among the organic peroxides, dicumyl peroxide, 2,5-dimethyl-2,5-di-(tert-butylperoxy)hexane (PERHEXA 25B), and 2,5-dimethyl-2,5-di-(tert-butylperoxy)hexyne-3 are preferable.

### <Carrier Resin>

The above-described silanol condensation catalyst may be mixed with a resin or rubber, if desired, and used. Such a resin or rubber (also referred to as “carrier resin”) is not particularly limited, and the components described for the base resin can be used. The carrier resin is preferably at least one kind of components forming the base resin from the viewpoint of compatibility with the base resin, and preferably contains the same component as the base resin.

### <Additive>

The silane crosslinkable composition of the present invention may contain various additives ordinarily used for the resin composition. Examples of such additives include an antioxidant, a lubricant, a metal inactivator, a plasticizer, a flame retardant, a flame retardant aid, and (co)polymers other than those described for the base resin.

### (Composition of Silane Crosslinkable Resin Composition)

The content of the compound having two or more imide structures in the silane crosslinkable resin composition is 1 to 60 parts by mass with respect to 100 parts by mass of the base resin. When the silane crosslinkable resin composition contains the compound having two or more imide structures within this range, it is possible to suppress the appearance defect and generation of lumps while allowing a silanol condensation reaction as a final crosslinking reaction to progress at a moderate rate together with a silanol condensation catalyst to construct a sufficient crosslinked structure by the silanol condensation reaction, thereby realizing a silane crosslinked resin formed body having both appearance characteristics and heat resistance. The content of the compound having two or more imide structures in the silane crosslinkable resin composition is preferably 2 to 60 parts by mass, more preferably 5 to 50 parts by mass, and still more preferably 7.5 to 45 parts by mass with respect to 100 parts by mass of the base resin, from the viewpoint that both the appearance characteristics and the heat resistance of the silane crosslinked resin formed body can be achieved at a high level in a well-balanced manner.

When the polyimide compound is reacted or decomposed, the content is determined in terms of the mass before reaction or decomposition.

The content of the silane coupling agent in the silane crosslinkable resin composition is not particularly limited, and is preferably 2 to 15 parts by mass, more preferably 2.5 to 10 parts by mass, and still more preferably 3 to 7.5 parts by mass, with respect to 100 parts by mass of the base resin, from the viewpoint that a silane crosslinked resin formed body having excellent appearance characteristics and a sufficient crosslinking density (heat resistance) can be produced by suppressing the appearance defect, generation of lumps, volatilization of the silane coupling agent, and the like. Here, in the silane crosslinkable resin composition, the silane coupling agent is graft-bonded to the polyolefin resin, and the content of the silane coupling agent is, for convenience, a content in terms of mass before being graft-reacted with the polyolefin resin (content of the silane coupling agent used in combination with the polyolefin resin).

The content of the silanol condensation catalyst in the silane crosslinkable resin composition is 0.01 to 5 parts by mass with respect to 100 parts by mass of the base resin. When the silane crosslinkable resin composition contains the silanol condensation catalyst within this range, it is possible to suppress appearance defects and generation of lumps while allowing a silanol condensation reaction as a final crosslinking reaction to progress at a moderate rate together with the compound having two or more imide structures to construct a sufficient crosslinked structure by the silanol condensation reaction, thereby realizing a silane crosslinked resin formed body having both appearance characteristics and heat resistance. The content of the silanol condensation catalyst in the silane crosslinkable resin composition is preferably 0.05 to 4 parts by mass, more preferably 0.075 to 3.5 parts by mass, still more preferably 0.1 to 3 parts by mass, and yet still more preferably 0.1 to 1 parts by mass, with respect to 100 parts by mass of the base resin, from the viewpoint that both the appearance characteristics and the heat resistance of the silane crosslinked resin formed body can be achieved at a high level in a well-balanced manner.

In the silane crosslinkable resin composition, the mass ratio of the content of the polyimide compound to the content of the silanol condensation catalyst [the content of the polyimide compound/the content of the silanol condensation catalyst] is not particularly limited and can be appropriately set. For example, the mass ratio [content of polyimide compound/content of silanol condensation catalyst] can be set to 0.2 to 6000, and is preferably 10 to 600, in that both the appearance characteristics and heat resistance of the silane crosslinked resin formed body can be achieved at a high level in a well-balanced manner.

In the present invention, the content of each of the compound having two or more imide structures, the silane coupling agent, and the silanol condensation catalyst can be set by appropriately combining preferable ranges of the respective components, as long as the appearance characteristics and heat resistance of the silane crosslinked resin composition can be achieved at a high level in a well-balanced manner.

The content of the inorganic filler in the silane crosslinkable resin composition is not particularly limited, and is, for example, preferably 0.5 to 400 parts by mass, more preferably 1 to 200 parts by mass, with respect to 100 parts by mass of the base resin, from the viewpoint of further improving the appearance characteristics and heat resistance of the silane crosslinked resin formed body. In the present invention, the gel fraction can be dramatically increased by using the compound having two or more imide structures, and the extrusion appearance can be improved by reducing the content of the inorganic filler. In this case, the content of the inorganic filler may be, for example, 1 to 300 parts by mass, more preferably 5 to 250 parts by mass, particularly preferably 10 to 200 parts by mass, and most preferably 20 to 100 parts by mass, with respect to 100 parts by mass of the base resin.

When an organic peroxide is used for the grafting reaction between the silane coupling agent and the base resin in the silane crosslinkable resin composition, the amount of the organic peroxide to be used is not particularly limited. For example, the amount is preferably 0.01 to 0.6 parts by mass, more preferably 0.05 to 0.5 parts by mass, and still more preferably 0.1 to 0.2 parts by mass with respect to 100 parts by mass of the base resin from the viewpoint that the grafting reaction between the silane coupling agent and the base resin can be efficiently caused to occur and progress. However, in the silane crosslinkable resin composition, the organic peroxide is ordinarily decomposed during the grafting reaction.

The total content of the additive in the silane crosslinkable resin composition is not particularly limited, and can be appropriately set as long as the action and effect of the present invention are not impaired. For example, the content of the antioxidant is not particularly limited, and is preferably 0.2 to 8 parts by mass with respect to 100 parts by mass of the base resin.

### (Composition of Silane Crosslinked Resin Formed Body)

Since the silane crosslinked resin formed body is formed by forming the silane crosslinkable resin composition and then bringing it into contact with water to cause a silanol condensation reaction, the content of each of the components in this formed body is ordinarily the same as the content in the silane crosslinkable resin composition. However, the organic peroxide and the silanol condensation catalyst are ordinarily decomposed. The content of the silane coupling agent before the silanol condensation reaction, and the content of the base resin before crosslinking are used.

In the silane crosslinkable resin composition and the silane crosslinked resin formed body of the present invention, it is ordinarily considered that the polyimide compound does not undergo a direct crosslinking reaction with the polyolefin resin, but depending on the kind of the polyimide compound and the like, for example, it is also considered that the polyimide compound may undergo hydrolysis (imide bond cleavage) to react with other components.

### Method of Producing Silane Crosslinkable Resin Composition

The silane crosslinkable resin composition of the present invention can be prepared by mixing the above-described components.

In an aspect in which a silane graft resin is used, the silane crosslinkable resin composition can be prepared by melt-mixing a silane graft resin, a compound having two or more imide structures, a silanol condensation catalyst, and if appropriate, an inorganic filler and an additive. As the method of melt-mixing, conditions, and the like, the method, conditions, and the like of the step (1) or the step (a) described later can be adopted.

Meanwhile, in an aspect in which the polyolefin resin and the silane coupling agent are subjected to a grafting reaction at the time of preparing the silane crosslinkable resin composition, the silane crosslinkable resin composition can be prepared by mixing a polyolefin resin, a silane coupling agent, an organic peroxide, a compound having two or more imide structures, a silanol condensation catalyst, and if appropriate, an inorganic filler and an additive. The mixing method (mixing order), conditions, and the like are not particularly limited, and the silane crosslinkable resin composition can be preferably produced by a method in which the inorganic filler is arbitrarily mixed in the method of producing a silane crosslinkable resin composition of a preferred embodiment described later.

The silane crosslinkable resin composition in a preferred embodiment containing an inorganic filler can be prepared by mixing the respective components as described above, except that the inorganic filler is contained as an essential component. It is preferable to prepare the silane crosslinkable resin composition in a preferred embodiment of the method of producing a silane crosslinkable resin composition (hereinafter, may be referred to as “preferred method of producing the crosslinkable resin composition of the present invention) described later.

### Method of Producing Silane Crosslinked Resin Formed Body

The silane crosslinked resin formed body of the present invention can be produced by forming the silane crosslinkable resin composition of the present invention and then bringing it into contact with water to cause a crosslinking reaction (silanol condensation reaction). The method of forming the silane crosslinkable resin composition, the forming conditions as well as the method of bringing the silane crosslinkable resin composition into contact with water and the contact conditions are not particularly limited, and respective methods and respective conditions described in the step (2) and the step (3) described later can be applied.

The silane crosslinked resin formed body in a preferred embodiment that contains an inorganic filler can be produced in a similar manner to the silane crosslinked resin formed body of the present invention except that the silane crosslinkable resin composition in a preferred embodiment is used. It is preferable to produce the silane crosslinked resin formed body by a method of producing a silane crosslinked resin formed body in a preferred embodiment described later (hereinafter, may be referred to as “preferred method of producing the formed body of the present invention”).

### Preferred Method of Producing Crosslinkable Resin Composition of Present Invention and Preferred Method of Producing Formed Body of Present Invention

Hereinafter, a preferred method of producing a crosslinkable resin composition of the present invention and a preferred method of producing a formed body of the present invention (both the production methods may be collectively referred to as “preferred production method of the present invention”) will be described. Each of the production methods is an aspect in which a polyolefin resin and a silane coupling agent are subjected to a grafting reaction during preparation of a composition.

Step (1): a step of obtaining a mixture (preferred embodiment of a silane crosslinkable resin composition) by melt-mixing, 100 parts by mass of a base resin containing a polyolefin resin, 2 to 15 parts by mass of a silane coupling agent having a grafting reaction site capable of being graft-reacted with the base resin, 1 to 60 parts by mass of a compound having two or more imide structures, 1 to 200 parts by mass of an inorganic filler, 0.01 to 0.6 parts by mass of an organic peroxide, and 0.01 to 5 parts by mass of a silanol condensation catalyst.

Step (2): a step of obtaining a formed body by forming the mixture obtained in the step (1).

Step (3): a step of obtaining a silane crosslinked resin formed body by bringing the formed body obtained in the step (2) into contact with water.

The step (1) includes the following steps depending on the use form (blending form) of the base resin.

That is, when the step (1) is performed, in a case of melt-mixing all of the base resin in the following step (a), the step (1) includes the following step (a) and step (c), or in a case of melt-mixing a part of the base resin in the following step (a), the step (1) includes the following step (a), step (b), and step (c).

In addition, the compound having two or more imide structures may be mixed in at least one of the following step (a) and step (b), and the whole amount thereof is preferably mixed in the following step (b) from the viewpoint that the appearance characteristics can be further enhanced while sufficient heat resistance is maintained.

Step (a): a step of preparing a silane masterbatch by melt-mixing all or a part of the base resin, the inorganic filler, the silane coupling agent, and an organic peroxide at a temperature equal to or higher than a decomposition temperature of the organic peroxide.

Step (b): a step of preparing a catalyst masterbatch by melt-mixing a remainder of the base resin and the silanol condensation catalyst.

Step (c): a step of melt-mixing the silane masterbatch with the silanol condensation catalyst or the catalyst masterbatch.

In the preferred production method of the present invention, the mixing amount of each component used as the base resin is the same as the content rate described above as the composition of the base resin. In addition, the mixing amounts of the compound having two or more imide structures, the silanol condensation catalyst, and the additive are the same as the contents in the silane crosslinkable resin composition described above. The mixing amount of the silane coupling agent is the same as the content in the above-described silane crosslinkable resin composition except that the mixing amount of the silane coupling agent is 2 to 15 parts by mass with respect to 100 parts by mass of the base resin. In addition, the mixing amount of the inorganic filler is the same as the content in the silane crosslinkable resin composition described above except that the mixing amount of the inorganic filler is 1 to 200 parts by mass with respect to 100 parts by mass of the base resin.

In the preferred production method of the present invention, 100 parts by mass of the base resin may be contained in the mixture obtained in the step (1). For example, the step (a) includes an aspect in which the whole amount (100 parts by mass) of the base resin is mixed and an aspect in which a part of the base resin is mixed.

When a part of the base resin is mixed in the step (a), the ratio thereof is preferably 60 to 95 mass %, more preferably 70 to 85 mass %, with respect to 100 mass % of the base resin mixed in the step (a) and step (b). The remainder (carrier resin) of the base resin to be mixed in the step (b) is appropriately determined according to a part of the base resin to be mixed in the step (a).

When a part of the base resin is mixed in the step (a), the component to be mixed may be one kind or two or more kinds.

A part of the inorganic filler can also be used in a step other than the step (a), for example, the step (b) or the like, and it is preferable to use the whole amount of the inorganic filler in the step (a) because a crosslinked structure (not involving the inorganic filler) between base resins and a crosslinked structure involving the inorganic filler can be constructed in a well-balanced manner. When the inorganic filler is used in the step (b), the amount of the inorganic filler used is not particularly limited, and is appropriately determined.

Various additives may be mixed in either the step (a) or the step (b).

### <Step (1)>

In a preferred production method of the present invention, the step (1) of preparing a silane crosslinkable resin composition in a preferred embodiment as a mixture by melt-mixing a base resin, a silane coupling agent, a compound having two or more imide structures, an inorganic filler, an organic peroxide, and a silanol condensation catalyst in the above-described mixing amount is performed.

The step (1), i.e. melt-mixing of the base resin, the silane coupling agent, the compound having two or more imide structures, the inorganic filler, the organic peroxide, and the silanol condensation catalyst is performed in the following order.

### (Step (a))

In a preferred production method of the present invention, the step (a) of preparing a silane masterbatch (silane MB) is performed by melt-mixing all or a part of a base resin, an inorganic filler, a silane coupling agent, an organic peroxide, and if appropriate, a compound having two or more imide structures, in the mixing amount described above at a temperature equal to or higher than the decomposition temperature of the organic peroxide.

In the step (a), the mixing temperature at which the above-described components are melt-mixed (also referred to as “melt-kneaded”) is equal to or higher than the decomposition temperature of the organic peroxide, preferably a temperature of the decomposition temperature of the organic peroxide plus (25 to 110)° C., more preferably 150 to 230° C., and still more preferably 175 to 210° C. Here, the decomposition temperature of the organic peroxide as a reference of the melt-mixing temperature is a temperature under an ordinary pressure (about 0.1 MPa) environment. Mixing conditions, such as, a mixing time can be appropriately set. For example, the mixing time can be 1 to 25 minutes, and is preferably 3 to 20 minutes. Melt-mixing is performed at a temperature equal to or higher than the decomposition temperature of the organic peroxide, and thus the organic peroxide is thermally decomposed to generate radicals, thereby the grafting reaction progresses.

The mixing method is not particularly limited as long as it is a method ordinarily used for mixing rubber, plastic, or the like. As a mixing device, for example, a single screw extruder, a twin screw extruder, a roll, a Banbury mixer, or various kneaders is used, and a sealed mixer such as a Banbury mixer or various kneaders is preferable.

The method of mixing the base resin is also not particularly limited. For example, the base resin may be prepared in advance and used, or each component may be separately used.

In the preferred production method of the present invention, the mixing order of the components in the step (a) is not specified, and the above-described components may be mixed in any order. For example, the components described above can be melt-mixed at a time, and can also be mixed in the following mixing order through the following step (a-1) and step (a-2). When the compound having two or more imide structures is mixed in the step (a), the compound having two or more imide structures may be mixed in either the step (a-1) or the step (a-2).

Step (a-1): A step of mixing the inorganic filler and the silane coupling agent to prepare a mixture.

Step (a-2): A step of melt-mixing the mixture obtained in the step (a-1) and all or a part of the base resin in the presence of an organic peroxide at a temperature equal to or higher than a decomposition temperature of the organic peroxide.

The inorganic filler and the silane coupling agent are premixed in the step (a-1), and thereby the silane coupling agent bonded or adsorbed to the inorganic filler by weak bonding and the silane coupling agent bonded or adsorbed to the inorganic filler by strong bonding can be formed in a well-balanced manner. This makes it possible to effectively prevent volatilization of the silane coupling agent and further condensation reaction between unadsorbed silane coupling agents at the time of melt-mixing in the step (a-2).

The mixing method and mixing conditions in the step (a-1) are not particularly limited, and examples thereof include a method and conditions in which mixing is performed by a dry method or a wet method, ordinarily at a temperature lower than the decomposition temperature of the organic peroxide, preferably 10 to 60° C., more preferably near room temperature (20 to 25° C.) for about several minutes to several hours using a known mixer, a kneader, or the like. Particularly, dry mixing (dry blending) is preferably performed at a temperature lower than the decomposition temperature of the organic peroxide. Other conditions for dry mixing are appropriately determined.

In the step (a-1), the base resin can be mixed as long as the temperature lower than the decomposition temperature is maintained.

The organic peroxide is only required to exist when melt-mixing in the step (a-2) is performed, and may be mixed in the step (a-2), or preferably mixed in the step (a-1).

Then, the mixture obtained in the step (a-1), all or a part of the base resin, and the remaining component unmixed in the step (a-1) are melt-mixed in the presence of the organic peroxide at a temperature equal to or higher than the decomposition temperature of the organic peroxide to prepare a silane MB (step (a-2)). In the melt-mixing in this step, it is possible to prevent an excessive crosslinking reaction (generation of gel lumps) between the base resins while suppressing the volatilization and self-condensation of the silane coupling agent described above.

The melt-mixing method and conditions in the step (a-2) are not particularly limited, and the melt-mixing method and conditions in the step (a) can be applied.

In the step (a-2), at least the following is considered as an aspect in which the silane coupling agent is graft-reacted with the base resin. That is, there is an aspect in which the silane coupling agent bonded or adsorbed to the inorganic filler by weak bonding is detached from the inorganic filler, and is graft-reacted with the base resin. From this aspect, the crosslinked structure formed in the step (3) as described later does not incorporate the inorganic filler, and ordinarily becomes a crosslinked structure through a silanol condensate between silane coupling agents. Further, there is an aspect in which the silane coupling agent bonded or adsorbed to the inorganic filler by strong bonding is graft-reacted with a base resin, in a state of maintaining the bond or adsorption to the inorganic filler. From the above aspect, the crosslinked structure formed in the step (3) as described later incorporates the inorganic filler, and becomes a crosslinked structure through a silane coupling agent bonded to the inorganic filler as a starting point. The crosslinked structures in both the aspects are mixed, so that it is possible to construct a highly developed crosslinked structure including a crosslinked structure in which an inorganic filler is spirally wound around a silane crosslinked resin formed body.

In the step (a), an additive, and the like can also be mixed. However, in the step (a), it is preferable that the silanol condensation catalyst is not substantially mixed. This makes it possible to suppress the occurrence of the silanol condensation reaction of the silane coupling agent. In the present invention, the phrase “not substantially mixed” does not meant to exclude the situation in which the silanol condensation catalyst unavoidably exists, and means that the silanol condensation catalyst may exist in a range that can suppress the silanol condensation reaction, for example, in a range of 0.01 parts by mass or less with respect to 100 parts by mass of the base resin.

The silane MB prepared in the step (a) contains a reaction mixture of the base resin, the silane coupling agent, the compound having two or more imide structures, and the inorganic filler, and contains a silane graft resin in which the silane coupling agent is graft-bonded to the base resin to such an extent that it can be formed through the step (b) as described later. The silane coupling agent graft-bonded to the base resin includes a silane coupling agent bonded or adsorbed to the inorganic filler at a silanol condensable reaction site.

The silane MB is preferably in the form of a pellet or a powder.

### (Step (b))

In the preferred production method of the present invention, the step (b) of melt-mixing the remainder of the base resin (carrier resin), the silanol condensation catalyst, and preferably the compound having two or more imide structures to prepare a catalyst masterbatch (catalyst MB) is performed, independently of the step (a) or after the step (a).

A mixing ratio between the carrier resin with the silanol condensation catalyst and the compound having two or more imide structures is not particularly limited. However, the mixing ratio is preferably set so that the above-described mixing amount in the step (1) is satisfied.

The melt-mixing method and conditions in the step (b) are not particularly limited, and the melt-mixing method and conditions in the step (a) can be applied. For example, the melt-mixing temperature may be equal to or higher than the melting temperature of the base resin, and is preferably 120 to 200° C., more preferably 140 to 180° C. Other conditions, such as a mixing time, can be appropriately set. For example, the mixing time can be 1 to 25 minutes, and is preferably 3 to 20 minutes.

The catalyst MB is preferably in the form of a pellet or a powder.

### (Step (c))

In the preferred production method of the present invention, the step (c) of obtaining a mixture by melt-mixing a silane MB and a silanol condensation catalyst or catalyst MB is then performed. Preferably, the silane MB and the catalyst MB are melt-mixed.

The mixing method is not particularly limited, but is basically similar to the melt-mixing in the step (a), and mixing is performed at a temperature at which at least the base resin melts. The mixing conditions in the step (c) are not particularly limited, and the mixing conditions in the step (a) can be applied. For example, the mixing temperature is appropriately selected according to the melting temperature of the base resin or the carrier resin, and is, for example, preferably 80 to 250° C., more preferably 100 to 240° C., and still more preferably 120 to 200° C. Other conditions, such as a mixing time, can be appropriately set.

In the melt-mixing in the step (c), a melt mixing method and conditions capable of maintaining the fluidity (formability) of the mixture are set. The silane graft resin in the mixture is an uncrosslinked body in which the silane coupling agent is not subjected to silanol condensation. Practically, when the melt-mixing is performed in the step (c), crosslinking of part (partial crosslinking) cannot be avoided, but formability is kept on the mixture to be obtained. For example, in order to avoid the occurrence or progress of the silanol condensation reaction, it is preferable that the silane MB and the silanol condensation catalyst are not kept in a high temperature state for a long period of time in the state of being mixed.

In the step (c), the silane MB and the silanol condensation catalyst or catalyst MB can be dry-blended before both are melt-mixed. A method and conditions of dry blending are not particularly limited, and specific examples thereof include dry mixing and conditions in the step (a-1).

In this manner, the silane crosslinkable resin composition of a preferred embodiment of the present invention is produced as a mixture.

This silane crosslinkable resin composition contains a silane graft resin, a silanol condensation catalyst, an inorganic filler, a compound having two or more imide structures, and the like. In the silane graft resin, the silanol condensable reaction site of the silane coupling agent may be bonded or adsorbed to the inorganic filler, but is not silanol condensed. Therefore, the silane graft resin contains the silane graft resin in which the silane coupling agent bonded or adsorbed to the inorganic filler is graft-bonded to the base resin, and the silane graft resin in which the silane coupling agent not bonded or adsorbed to the inorganic filler is graft-bonded to the base resin.

### <Step (2)>

In the preferred method of producing a formed body of the present invention, the step (2) of obtaining a formed body by forming the mixture (silane crosslinkable resin composition in a preferred embodiment of the present invention) obtained in the step (1) is then performed.

The forming method is not particularly limited, and is appropriately selected according to the form of the target product. Examples of the forming method include extrusion forming using an extruder, extrusion forming using an injection forming machine, forming using another forming machine, and spiral forming described later. In the case of producing a wiring material, the extrusion forming method is preferable from the viewpoint of productivity, and further from the viewpoint of being able to perform coextrusion with a conductor, and the like.

The forming conditions (melt-mixing conditions) are not particularly limited as long as they are conditions under which uniform mixing and forming can be achieved, and the silane crosslinkable resin composition according to a preferred embodiment of the present invention does not cause a silanol condensation reaction, and for example, the melt-mixing method and conditions of the step (a) can be applied.

In the case of using an extruder, the temperature of the extruder is preferably set to about 120 to 180° C. for a cylinder part and about 160 to 200° C. for the crosshead part (die), although depending on various conditions such as kind of the base resin and take-up speed of the conductor or the like. A screw rotation speed and a forming speed (linear velocity) in the extrusion forming are not particularly limited, and can be appropriately set according to the characteristics or performance of the extruder, the extrusion amount (coating amount), and the like. The linear velocity can be ordinarily set to 1 to 20 m/min.

The step (2) can be performed simultaneously with the step (c) or both the steps can be continuously performed. For example, a series of steps can be employed in which the silane MB is mixed with the silanol condensation catalyst or the catalyst MB by dry blending or the like immediately before a coating device (extruder), and then melt-mixed in a coating device (step (c)), or the silane MB and the silanol condensation catalyst or the catalyst MB are separately placed in the coating device, and subsequently, melt-mixed (step (c)) and formed (coextrusion-formed) (step (2)) on an outer peripheral of a conductor or the like.

In this manner, a formed body (uncrosslinked formed body) of the silane crosslinkable resin composition according to the preferred embodiment of the present invention is obtained. Similarly to the silane crosslinkable resin composition of a preferred embodiment, partial crosslinking is unavoidable, and this formed body is in a partially crosslinked state of keeping formability at which the composition can be formed in the step (2). Therefore, this silane crosslinked resin formed body of a preferred embodiment of the present invention is obtained as the formed body crosslinked or finally crosslinked, by performing the step (3).

### <Step (3)>

In the preferred method of producing a formed body of the present invention, the step (3) of producing the silane crosslinked resin formed body of a preferred embodiment of the present invention by bringing the formed body obtained in the step (2) and water into contact with each other is then performed. In the formed body obtained in the step (2), the silane crosslinked resin is an uncrosslinked body, in this step, a silanol condensation reaction (dehydration condensation reaction) of a silanol condensable reaction site of the silane coupling agent graft-bonded to the base resin is caused to occur and progress (accelerate), and finally silane crosslinking is performed. Thus, the silane crosslinked resin formed body in which the silane coupling agent is subjected to silanol condensation and crosslinked can be obtained.

The contact between the uncrosslinked formed body and water can be performed by an ordinary method. Since the silanol condensation reaction progresses only by being left standing at room temperature, for example, in a temperature environment of about 20 to 25° C. in the presence of moisture, it is not necessary to actively bring the uncrosslinked formed body into contact with water. From the viewpoint of accelerating the silanol condensation reaction (crosslinking reaction), it is preferable to actively bring the uncrosslinked formed body and water into contact with each other. Examples of the contact method include a method (condition) ordinarily applied to the silane crosslinking method, and examples thereof include a method of performing contact under an ordinary pressure environment, and specific examples thereof include exposure to a saturated water vapor atmosphere, exposure to a high humidity environment, immersion in water at room temperature or warm water (e.g. 50 to 90° C.), placement in a wet heat bath, exposure to high temperature water vapor. In addition, pressure may be applied to in order to penetrate moisture thereinto on the contact.

In this manner, the silane crosslinked resin formed body according to a preferred embodiment of the present invention is produced.

This silane crosslinked resin formed body contains a silane crosslinked resin in which a base resin (silane crosslinkable resin) is condensed through a siloxane bond. The silane crosslinked resin formed body contains an inorganic filler, and the inorganic filler may be bonded to the silane coupling agent of the crosslinked base resin. Therefore, it is considered that the silane crosslinked resin contains a crosslinked resin in which a plurality of base resins is bonded or adsorbed to an inorganic filler by a silane coupling agent and bonded (crosslinked) through the inorganic filler and the silane coupling agent, and a crosslinked resin in which the silanol condensable reaction sites of the silane coupling agent graft-bonded to the base resin are hydrolyzed and subjected to condensation reaction with each other to be crosslinked through the silane coupling agent (siloxane bond) (without through the inorganic filler).

In the preferred method of producing a formed body of the present invention, the compound having two or more imide structures is present when the final crosslinking reaction in the step (3) is caused to occur and progress. Accordingly, the final crosslinking reaction (silanol condensation reaction) in the step (3) can be allowed to progress at a moderate reaction rate, and a silane crosslinked resin formed body can be produced in which both the appearance characteristics and heat resistance, which are conflicted with each other depending on the fastness and slowness of the silanol condensation reaction, are achieved in a well-balanced manner.

The silane crosslinked resin formed body of the present invention has excellent appearance characteristics and high heat resistance, and can be suitably used for various products (also includes semi-finished products, parts and members). Specific examples thereof include resin formed body substitutes such as an insulating coating layer (including a sheath) of a wiring material, a molding material, a plug for power supply, a connector, a sleeve, a box, a tape base material, a tube, a heat-resistant sheet, a heat-resistant film, a packing, a gasket, a cushion material, and a vibration-proof material. Particularly, the silane crosslinked resin formed body of the present invention is suitably used as an insulating coating layer of an insulated wire for a vehicle such as an automobile or an electric train, or as a sheath of a cabtyre cable by utilizing excellent characteristics of the silane crosslinked resin formed body.

### Wiring Material

The wiring material of the present invention has the silane crosslinked resin formed body of the present invention or the silane crosslinked resin formed body of a preferred embodiment of the present invention formed into a tubular shape as a coating layer (such as an insulating layer or a sheath) coating the outer periphery of the conductor. The wiring material (coating layer) of the present invention exhibits excellent appearance characteristics and high heat resistance. The wiring material of the present invention means, unless otherwise specified, a wiring material used for internal wiring or external wiring of electric or electronic devices, and encompasses an insulated wire, a cable, a cord, an optical fiber core wire, or an optical fiber cord (optical fiber cable).

The wiring material is the same as an ordinary wiring material used in various electrical-or electronic-equipment fields and industrial fields, except that the coating layer is formed of the silane crosslinked resin formed body of the present invention or the silane crosslinked resin formed body of a preferred embodiment of the present invention. Here, when the coating layer of the wiring material is formed of a plurality of layers, at least one of the layers may be formed of the silane-crosslinked resin formed body of the present invention or the silane crosslinked resin formed body of a preferred embodiment of the present invention. The coating layer formed of the silane crosslinked resin formed body of the present invention or the silane crosslinked resin formed body of a preferred embodiment of the present invention is provided directly or through another layer on the outer periphery of a conductor. The presence or absence of another layer, the material, and the like are appropriately determined according to the kind, application, required characteristics, and the like of the electric wire.

As the conductor, an ordinary conductor can be used, and examples thereof include a single wire or a twisted wire (one obtained by vertically attaching or twisting tensile strength fibers) of soft copper, copper alloy, or aluminum. Moreover, in addition to a bare wire, a tin-plated conductor or a conductor having an enamel-coating insulation layer can be used. The thickness of the coating layer formed of the silane crosslinked resin formed body of the present invention or the silane crosslinked resin formed body of a preferred embodiment of the present invention is not particularly limited. Ordinarily, the thickness is about 0.15 to 5 mm.

The wiring material of the present invention can be produced by forming the silane crosslinkable resin composition of the present invention or the silane crosslinked resin formed body of a preferred embodiment of the present invention into a toroid-shaped layer (tubular shape) on the outer periphery of a conductor, and then bringing the layer into contact with water to cause a crosslinking reaction (silanol condensation reaction). Preferably, in the preferred method of producing a formed body of the present invention described above, the wiring material can be produced by setting the forming step (2) to the step of coextrusion forming of the silane crosslinkable resin composition of a preferred embodiment of the present invention onto the outer periphery of the conductor using a coating device (extruder). In the preferred method of producing a formed body of the present invention described above, a wiring material having a coating layer formed of the silane crosslinkable resin composition of the present invention can be produced through the step of coextrusion forming of the silane crosslinkable resin composition of the present invention onto the outer periphery of the conductor, by not mixing the inorganic filler.

### EXAMPLES

Hereinafter, the present invention will be described in more detail based on Examples, but the present invention is not limited to these.

The details of the compounds used in Examples and Comparative Examples are shown in Tables 1 to 3 and below.

### Base Resin

### (Silane Graft Resin)

Linklon XCF730M (trade name): silane graft polyethylene, content of silane coupling agent: 5 mass %, manufactured by Mitsubishi Chemical Corporation

### (Polyolefin Resin)

LLDPE: EVOLUE SP0540 (trade name), linear low-density polyethylene, manufactured by Prime Polymer Co., Ltd.

PP: PB222A (trade name), manufactured by SunAllomer Ltd., random polypropylene resin

EVA: EVAFLEX EV360 (trade name), ethylene-vinyl acetate copolymerized resin, manufactured by DOW-MITSUI POLYCHEMICALS CO., LTD.

Metallocene-based plastomer: KERNEL KS-240T (trade name), polyethylene, manufactured by Japan Polyethylene Corporation

SEEPS: SEPTON 4077 (trade name), styrene-ethylene-ethylene-propylene-styrene block copolymer, manufactured by KURARAY CO., LTD.

Oil: COSMO NEUTRAL 500 (trade name), paraffin oil, manufactured by COSMO OIL LUBRICANTS Co., Ltd.

Malein-modified PP: ADMER QE800 (trade name), manufactured by Mitsui Chemicals, Inc.

Epoxy-modified PE: Bondfast E (trade name), manufactured by Sumitomo Chemical Co., Ltd.

### Compound Having Two or More Imide Structures

4,4′-diphenylmethane bismaleimide: BMI-1000H, manufactured by DAIWA KASEI INDUSTRIAL Co., Ltd.

Bisphenol A diphenyl ether bismaleimide: BMI-4000, manufactured by DAIWA KASEI INDUSTRIAL Co., Ltd.

3,3′-dimethyl-5,5′-diethyl-4,4′-diphenylmethane bismaleimide: BMI-5100, manufactured by DAIWA KASEI INDUSTRIAL Co., Ltd.

Phenylmethane maleimide: BMI-2300, manufactured by DAIWA KASEI INDUSTRIAL Co., Ltd.

Triallyl isocyanurate: TAIC (trade name), manufactured by Mitsubishi Chemical Corporation

Tris(2,3-dibromopropyl) isocyanurate: TAIC-6B (trade name), manufactured by Mitsubishi Chemical Corporation

Ethylene bis(tetrabromophthalimide): CG-952, manufactured by SUN CHEMICAL COMPANY LTD.

### Silane Coupling Agent

Silane coupling agent: KBM-1003 (trade name), manufactured by Shin-Etsu Chemical Co., Ltd., vinyltrimethoxysilane

### Organic Peroxide

Organic peroxide: PERHEXA 25B (trade name), manufactured by NOF Corporation., 2,5-dimethyl-2,5-di(tert-butylperoxy)hexane, decomposition temperature 154° C.

### Inorganic Filler

Magnesium hydroxide: MAGSEEDS FK640 (trade name), manufactured by Konoshima Chemical Co., Ltd.

### Silanol Condensation Catalyst

Dioctyltin dilaurate: ADK STAB OT-1 (trade name), manufactured by ADEKA CORPORATION

### Examples 1 to 25 and Comparative Examples 1 to 4

Each of Examples 1 to 25 and Comparative Examples 1 to 4 was carried out using the components shown in Tables 1 to 3.

In Tables 1 to 3, the numerical values for the composition amount (content) of the respective examples and comparative examples are in terms of part by mass, unless otherwise specified. In addition, in each component column, the blank means that a composition amount of a corresponding component is 0 part by mass.

In each of the examples (excluding Example 11) and the comparative examples, part (30 mass %) of the base resin was used as a carrier resin of a catalyst MB.

A silane graft resin or a polyolefin resin, a modified polyolefin resin, an inorganic filler, an organic peroxide, a silane coupling agent, and a polyimide compound shown in the column “Silane MB” in Tables 1 to 3 were melt-mixed at 170 to 200° C. at the mass ratio shown in the same column using a Banbury mixer, and then pelletized to prepare pellets of silane MB (step (a)).

Meanwhile, a carrier resin, a silanol condensation catalyst, and a polyimide compound shown in the column “Catalyst MB” in Tables 1 to 3 were melt-mixed at 170 to 200° C. at the mass ratio shown in the same column using a Banbury mixer, and then pelletized to prepare pellets of catalyst MB (step (b)).

Then, the prepared pellets of silane MB and pellets of catalyst MB were dry-blended at a mass ratio shown in the columns “Silane MB” and “Catalyst MB” in Tables 1 to 3 at room temperature (25° C.) for 2 minutes using a tumbler mixer, immediately before extrusion forming, to obtain a dry-blended product (dry blending step in the step (c)).

Then, a 25-mm (screw diameter) extruder (ratio of a screw effective length L to a diameter D: L/D=25) was set to an extrusion conditions with a die temperature of 200° C., and with a cylinder temperature, divided into three zones toward the feeder side, of C3=180° C., C2=160° C., and C1=140° C. The dry-blended product thus prepared was introduced into the extruder. While the product was melt-mixed at a screw rotation speed of 10 to 40 rpm (melt-mixing step in the step (c)), extrusion coating was performed on a 1.9 mmφ conductor made of a tin-plated copper stranded wire at a linear velocity adjusted to have an outer diameter of 2.6 mmφ and a thickness of 0.35 mm to obtain a coated conductor (step (2)). In this case, the dry-blended product is melt-mixed in the extruder before extrusion forming, and thus a silane crosslinkable resin composition is prepared.

The resulting coated conductor was left standing in an environment of room temperature (25° C.) and a relative humidity of 50RH % for 12 hours to bring the silane crosslinkable resin composition and water into contact with each other (step (3)).

In this manner, electric wires each having a coating layer formed of a silane crosslinked resin formed body was produced.

The following tests were performed on each produced electric wire, and comprehensive evaluation was performed based on each test result. The results are shown in Tables 1 to 3.

### Comprehensive Evaluation

In Test 1 and Test 2 below, a case where all the test samples passed was determined to be acceptable and rated as “◯”, and a case where even one test sample failed was determined to be unacceptable and rated as “×”.

### Test 1: Appearance Characteristic Test

The appearance characteristic test of the electric wire is an alternative test for evaluating the high rate of the crosslinking rate (silanol condensation reaction rate) of the silane crosslinkable resin composition (silane crosslinked resin formed body). The surface of the coating layer of each produced electric wire was visually observed to evaluate the appearance defect and the presence or absence of lumps.

Specifically, regarding the “appearance defect”, the presence or absence of foaming and the presence or absence of recesses and protrusions and roughness on the surface (appearance) of the coating layer were confirmed. Regarding “lumps”, the presence or absence of gel-like protruding aggregates (gel lumps) formed by the final crosslinking reaction (silanol condensation reaction) or aggregated lumps in which raw materials were aggregated due to being incompatible was confirmed on the surface of the coating layer.

A case where the appearance defect and the presence of lumps could not be confirmed on the surface of the coating layer was evaluated as very favorable and rated as “⊙”; a case where the appearance defect and the presence of lumps could be confirmed in the electric wire immediately after production (up to a production length of 5 m (not including 5 m)), but the appearance defect and the presence of lumps could not be confirmed in the electric wire having a production length of 5 m or more and up to 10 m (not including 10 m) was evaluated as favorable and rated as “◯”; a case where the appearance defect and the presence of lumps could not be confirmed for the first time in the electric wire having a production length of 10 m or more and up to 50 m (not including 50 m) was evaluated as acceptable and rated as “Δ”; and a case where the appearance defect or the presence of lumps could be confirmed in the electric wire having a production length of 50 m or more was evaluated as unacceptable and rated as “×”.

### Test 2: Heating Deformation Test

This test is an alternative test for evaluating the heat resistance (crosslinking density) of the coating layer and the slow rate of the crosslinking rate. The heating deformation ratio of each of the produced electric wires was measured in accordance with UL758.

Specifically, at a measurement temperature of 121° C., a load of 2.45 N was applied to each of the produced electric wires in a direction perpendicular to the longitudinal direction. In this situation, the deformation ratio ([(thickness of coating layer before heating−thickness of coating layer after heating)/thickness of coating layer before heating]×100) of the coating layer was calculated as the heating deformation ratio.

In a case where the heating deformation ratio was less than 30%, the silanol condensation reaction progressed rapidly to construct a high crosslinking density (high heat resistance could be realized), and the case was evaluated as very favorable and rated as “⊙”. A case where the heating deformation ratio was 30% or more and less than 40% was evaluated as favorable and rated as “◯”, a case where the heating deformation rate was 40% or more and less than 50% was evaluated as acceptable and rated as “Δ”, and a case where the heating deformation rate was 50% or more was evaluated as unacceptable and rated as “×”.

### Test 3: Hydrogen Halide Gas Generation Test

Halogen element-Quantitative analysis was performed on test pieces (2 g) collected from the coating layers of the produced electric wires in accordance with Japanese Cable Makers' Association Standard (JCS) No. 397 A-98 Section 7. Specifically, the test pieces were combusted in a quartz glass combustion tube under a condition of 750° C. or higher for 30 minutes, and then the generated gas was absorbed into the liquid in the absorption bottle, the absorbing liquid was examined, and the pH was measured.

This test was a reference test, and a case where the pH of the absorbing liquid was 4.0 or more was evaluated as favorable (generation of hydrogen halide gas was small) and rated as “◯”, and a case where the pH was less than 4.0 was evaluated as “unacceptable”: generation of hydrogen halide gas was large, and rated as “×”.

TABLE 1

| | | | Examples | | | | Comparative Examples | | | | | |
|---|---|---|---|---|---|---|---|---|---|---|---|---|
| | | | 1 | 2 | 3 | 4 | 1 | 2 | 3 | 4 | 5 | 6 |
| Silane | Silane graft resin | Silene graft PE | | | | | | | | | | |
| MB | Polyolefin resin | LLDPE | 70 | 70 | 70 | 70 | 70 | 70 | 70 | 70 | 70 | 70 |
| | | PP | | | | | | | | | | |
| | | EVA | | | | | | | | | | |
| | | Metallocene-based plastomer | | | | | | | | | | |
| | | SEEPS | | | | | | | | | | |
| | | Oil | | | | | | | | | | |
| | Inorganic filler | Magnesium hydroxide | 60 | 60 | 60 | 60 | 60 | 60 | 60 | 60 | 60 | 60 |
| | Organic peroxide | PERHEXA 25B | 0.1 | 0.1 | 0.1 | 0.1 | 0.1 | 0.1 | 0.1 | 0.1 | 0.1 | 0.1 |
| | Silane coupling agent | KBM-1003 | 3 | 3 | 3 | 3 | 3 | 3 | 3 | 3 | 3 | 3 |
| | Polyimide compound | 4,4′-diphenylmethane bismaleimide | | | | | | | | | | |
| Catalyst | Carrier resin | LLDPE | 30 | 30 | 30 | 30 | 30 | 30 | 30 | 30 | 30 | 30 |
| MB | Silanol condensation | Dioctyltin dilaurate | 0.1 | 0.1 | 0.005 | 10 | 0.1 | 0.1 | 0.1 | 0.1 | 0.01 | 5 |
| | catalyst | | | | | | | | | | | |
| | Polyimide compound | 4,4′-diphenylmethane bismaleimide | 0.5 | 65 | 35 | 35 | 35 | 17.5 | 1 | 60 | 35 | 35 |
| | | Bisphenol A diphenyl ether bismaleimide | | | | | | 17.5 | | | | |
| | | 3,3′-dimethyl-5,5′-diethyl-4,4′- | | | | | | | | | | |
| | | diphenylmethane bismaleimide | | | | | | | | | | |
| | | Phenylmethane maleimide | | | | | | | | | | |
| | | Triallyl isocyanurate | | | | | | | | | | |
| | | Tris(2,3-dibromopropyl)isocyanurate | | | | | | | | | | |
| | | Ethylene bis(tetrabromophthalimide) | | | | | | | | | | |

| Evaluation | Comprehensive Evaluation | X | X | X | X | ◯ | ◯ | ◯ | ◯ | ◯ | ◯ |
|---|---|---|---|---|---|---|---|---|---|---|---|
| | Appearance characteristic test | ⊚ | X | ⊚ | X | ⊚ | ⊚ | ⊚ | ◯ | ⊚ | ◯ |
| | Heating deformation test | X | ⊚ | X | ⊚ | ⊚ | ⊚ | ◯ | ⊚ | ◯ | ⊚ |
| | Hydrogen halide gas generation test | ◯ | ◯ | ◯ | ◯ | ◯ | ◯ | ◯ | ◯ | ◯ | ◯ |

TABLE 2

| | | | Examples | | | | | | | | | |
|---|---|---|---|---|---|---|---|---|---|---|---|---|
| | | | 7 | 8 | 9 | 10 | 11 | 12 | 13 | 14 | 15 | 16 |
| Silane | Silane graft resin | Silene graft PE | | | | | 105 | | | | | |
| MB | Polyolefin resin | LLDPE | 70 | 70 | 70 | 70 | | 70 | 70 | 70 | 70 | 70 |
| | | PP | | | | | | | | | | |
| | | EVA | | | | | | | | | | |
| | | Metallocene-based plastomer | | | | | | | | | | |
| | | SEEPS | | | | | | | | | | |
| | | Oil | | | | | | | | | | |
| | Inorganic filler | Magnesium hydroxide | 1 | 200 | 0 | 210 | 60 | 60 | 60 | 60 | 60 | 60 |
| | Organic peroxide | PERHEXA 25B | 0.1 | 0.1 | 0.1 | 0.1 | | 0.1 | 0.1 | 0.1 | 0.1 | 0.1 |
| | Silane coupling agent | KBM-1003 | 3 | 3 | 3 | 3 | | 3 | 3 | 3 | 3 | 3 |
| | Polyimide compound | 4,4′-diphenylmethane bismaleimide | | | | | | 35 | | | | |
| Catalyst | Carrier resin | LLDPE | 30 | 30 | 30 | 30 | | 30 | 30 | 30 | 30 | 30 |
| MB | Silanol condensation | Dioctyltin dilaurate | 0.1 | 0.1 | 0.1 | 0.1 | 0.1 | 0.1 | 0.1 | 0.1 | 0.1 | 0.1 |
| | catalyst | | | | | | | | | | | |
| | Polyimide compound | 4,4′-diphenylmethane bismaleimide | 35 | 35 | 35 | 35 | 35 | | | | | |
| | | Bisphenol A diphenyl ether bismaleimide | | | | | | | 35 | | | |
| | | 3,3′-dimethyl-5,5′-diethyl-4,4′- | | | | | | | | 35 | | |
| | | diphenylmethane bismaleimide | | | | | | | | | | |
| | | Phenylmethane maleimide | | | | | | | | | 35 | |
| | | Triallyl isocyanurate | | | | | | | | | | |
| | | Tris(2,3-dibromopropyl)isocyanurate | | | | | | | | | | |
| | | Ethylene bis(tetrabromophthalimide) | | | | | | | | | | 35 |

| Evaluation | Comprehensive Evaluation | ◯ | ◯ | ◯ | ◯ | ◯ | ◯ | ◯ | ◯ | ◯ | ◯ |
|---|---|---|---|---|---|---|---|---|---|---|---|
| | Appearance characteristic test | ⊚ | ◯ | ⊚ | Δ | Δ | Δ | ⊚ | ⊚ | ⊚ | ⊚ |
| | Heating deformation test | ◯ | ⊚ | Δ | ⊚ | ⊚ | ⊚ | ⊚ | ⊚ | ⊚ | ⊚ |
| | Hydrogen halide gas generation test | ◯ | ◯ | ◯ | ◯ | ◯ | ◯ | ◯ | ◯ | ◯ | X |

TABLE 3

| | | | Examples | | | | | | | | |
|---|---|---|---|---|---|---|---|---|---|---|---|
| | | | 17 | 18 | 19 | 20 | 21 | 22 | 23 | 24 | 25 |
| Silane | Silane graft resin | Silane graft PE | | | | | | | | | |
| MB | Polyolefin resin | LLDPE | 50 | 50 | 45 | 60 | | | | 70 | 70 |
| | | PP | | | | | 70 | | | | |
| | | EVA | | | | | | 70 | | | |
| | | Metallocene-based plastomer | | | | | | | 70 | | |
| | | SEEPS | | | 15 | 10 | | | | | |
| | | Oil | | | 10 | | | | | | |
| | Modified polyolefin | Maleic acid-modified PP | 20 | | | | | | | | |
| | resin | Epoxy-modified PE | | 20 | | | | | | | |
| | Inorganic filler | Magnesium hydroxide | 60 | 60 | 60 | 60 | 60 | 60 | 60 | 60 | 60 |
| | Organic peroxide | PERHEXA 258 | 0.1 | 0.1 | 0.1 | 0.1 | 0.1 | 0.1 | 0.1 | 0.1 | 0.1 |
| | Silane coupling agent | KBM-1003 | 3 | 3 | 3 | 3 | 3 | 3 | 3 | 3 | 3 |
| | Polyimide compound | 4,4′-diphenylmethane bismalaimide | | | | | | | | | |
| Catalyst | Carrier resin | LLDPE | 30 | 30 | 30 | 30 | 30 | 30 | 30 | 30 | 30 |
| MB | Silanol condensation | Dioctyltin dilaurate | 0.1 | 0.1 | 0.1 | 0.1 | 0.1 | 0.1 | 0.1 | 0.1 | 0.1 |
| | catalyst | | | | | | | | | | |
| | Polyimide compound | 4,4′-diphenylmethane bismaleimide | 35 | 35 | 35 | 35 | 35 | 35 | 35 | | |
| | | Triallyl isocyanurate | | | | | | | | 10 | |
| | | Tris(2,3-dibromopropyl)isocyanurate | | | | | | | | | 10 |
| | | Ethylene bis(tetrabromophthalimide) | | | | | | | | | |

| Evaluation | Comprehensive Evaluation | ◯ | ◯ | ◯ | ◯ | ◯ | ◯ | ◯ | ◯ | ◯ |
|---|---|---|---|---|---|---|---|---|---|---|
| | Appearance characteristic test | Δ | Δ | ⊚ | ⊚ | ⊚ | ⊚ | ⊚ | ⊚ | ⊚ |
| | Heating deformation test | ⊚ | ⊚ | ⊚ | ⊚ | ⊚ | ⊚ | ⊚ | ◯ | ◯ |
| | Hydrogen halide gas generation test | ◯ | ◯ | ◯ | ◯ | ◯ | ◯ | ◯ | ◯ | X |

The following can be seen from the results shown in Tables 1 to 3.

That is, in any of Comparative Examples 1 to 4 in which the content of the compound having two or more imide structures or the silanol condensation catalysts in the silane crosslinkable resin composition deviates from the range defined in the present invention, it is not possible to produce a silane crosslinked resin formed body exhibiting excellent appearance characteristics and high heat resistance.

On the other hand, in Examples 1 to 25 in which the compound having two or more imide structures was allowed to coexist with the silanol condensation catalyst at a specific ratio during the final crosslinking reaction of the silane crosslinkable resin composition containing the silanol condensation catalyst at a specific ratio, it is possible to produce a silane crosslinked resin formed body exhibiting excellent appearance characteristics and high heat resistance with excellent manufacturability. This is considered to be because the silanol condensation reaction, which is the final crosslinking reaction in the silane crosslinking method, can be caused to progress at a moderate reaction rate, i.e. the reaction rate of the silanol condensation reaction can be adjusted to such an extent that both excellent appearance characteristics and high heat resistance can be achieved.

In particular, when the modified polyolefin resin described above is not contained as the base resin, generation of lumps can be effectively suppressed and the appearance characteristics can be increased to a high level. Meanwhile, when the bromine-based flame retardant having a phthalimide structure or an isocyanurate ring structure is not contained as the compound having two or more imide structures, both excellent appearance characteristics and high heat resistance can be achieved, generation of a hydrogen halide gas is also suppressed, and environmental compatibility is excellent.

Having described our invention as related to the embodiments, it is our intention that the invention not be limited by any of the details of the description, unless otherwise specified, but rather be construed broadly within its spirit and scope as set out in the accompanying claims.

1. A silane crosslinkable resin composition comprising:
100 parts by mass of a base resin containing a polyolefin resin;
a silane coupling agent graft-bonded to the base resin;
1 to 60 parts by mass of a compound having two or more imide structures; and
0.01 to 5 parts by mass of a silanol condensation catalyst.

2. The silane crosslinkable resin composition according to claim 1, wherein the base resin does not contain a modified polyolefin resin modified with any of a carboxylic acid group, a methacrylic group, and an epoxy group.

3. The silane crosslinkable resin composition according to claim 1, wherein the compound having two or more imide structures does not contain a bromine-based flame retardant having a phthalimide structure.

4. The silane crosslinkable resin composition according to claim 1, comprising 1 to 200 parts by mass of an inorganic filler with respect to 100 parts of the base resin.

5. A silane crosslinked resin formed body of the silane crosslinkable resin composition according to claim 1.

6. A wiring material comprising the silane crosslinked resin formed body according to claim 5 as a coating layer.

7. A method of producing a silane crosslinkable resin composition, comprising a step (1) of obtaining a silane crosslinkable resin composition by melt-mixing, 100 parts by mass of a base resin containing a polyolefin resin, 2 to 15 parts by mass of a silane coupling agent having a grafting reaction site capable of being graft-reacted with the base resin, 1 to 60 parts by mass of a compound having two or more imide structures, 1 to 200 parts by mass of an inorganic filler, 0.01 to 0.6 parts by mass of an organic peroxide, and 0.01 to 5 parts by mass of a silanol condensation catalyst,
wherein, when the step (1) is performed, in a case of melt-mixing all of the base resin in the following step (a), the step (1) includes the following step (a) and step (c), or in a case of melt-mixing a part of the base resin in the following step (a), the step (1) includes the following step (a), step (b), and step (c):
Step (a): a step of preparing a silane masterbatch by melt-mixing all or a part of the base resin, the inorganic filler, the silane coupling agent, and the organic peroxide at a temperature equal to or higher than a decomposition temperature of the organic peroxide;
Step (b): a step of preparing a catalyst masterbatch by melt-mixing a remainder of the base resin and the silanol condensation catalyst; and
Step (c): a step of melt-mixing the silane masterbatch with the silanol condensation catalyst or the catalyst masterbatch,
wherein the compound having two or more imide structures is mixed in at least one of the step (a) and the step (b).

8. The method of producing a silane crosslinkable resin composition according to claim 7, wherein a whole amount of the compound having two or more imide structures is mixed in the step (b).

9. A method of producing a silane crosslinked resin formed body comprising the following step (1), step (2), and step (3):
Step (1): a step of obtaining a mixture by melt-mixing, 100 parts by mass of a base resin containing a polyolefin resin, 2 to 15 parts by mass of a silane coupling agent having a grafting reaction site capable of being graft-reacted with the base resin, 1 to 60 parts by mass of a compound having two or more imide structures, 1 to 200 parts by mass of an inorganic filler, 0.01 to 0.6 parts by mass of an organic peroxide, and 0.01 to 5 parts by mass of a silanol condensation catalyst;
Step (2): a step of obtaining a formed body by forming the mixture obtained in the step (1); and
Step (3): a step of obtaining a silane crosslinked resin formed body by bringing the formed body obtained in the step (2) and water into contact with each other,
wherein, when the step (1) is performed, in a case of melt-mixing all of the base resin in the following step (a), the step (1) includes the following step (a) and step (c), or in a case of melt-mixing a part of the base resin in the following step (a), the step (1) includes the following step (a), step (b), and step (c):
Step (a): a step of preparing a silane masterbatch by melt-mixing all or a part of the base resin, the inorganic filler, the silane coupling agent, and the organic peroxide at a temperature equal to or higher than a decomposition temperature of the organic peroxide;
Step (b): a step of preparing a catalyst masterbatch by melt-mixing a remainder of the base resin and the silanol condensation catalyst; and
Step (c): a step of melt-mixing the silane masterbatch with the silanol condensation catalyst or the catalyst masterbatch,
wherein the compound having two or more imide structures is mixed in at least one of the step (a) and the step (b).

10. The method of producing a silane crosslinked resin formed body according to claim 9, wherein a whole amount of the compound having two or more imide structures is mixed in the step (b).

11. A silane crosslinkable resin composition produced by the production method according to claim 7.

12. A silane crosslinked resin formed body produced by the production method according to claim 9.

13. A wiring material comprising the silane crosslinked resin formed body according to claim 12 as a coating layer.
